(19) United States
(12) Patent Application Publication
(10) Pub. No.: US 2018/0065815 A1
(43) Pub. Date: Mar. 8, 2018

(54) VOLUMETRIC FEEDER

(71) Applicant: Kun-Nan Yang, Taichung City (TW)

(72) Inventor: Kun-Nan Yang, Taichung City (TW)

(73) Assignee: SEMLIMA INDUSTRIAL CO., LTD., Taichung City (TW)

(21) Appl. No.: 15/258,762

(22) Filed: Sep. 7, 2016

(51) Int. Cl. B65G 47/82; G01F 11/44; B65G 47/19

(52) U.S. Cl. CPC B65G 47/82; G01F 11/44; B65G 2203/0283; B65G 2201/04; B65G 47/19

(57) ABSTRACT

A volumetric feeder may comprise a driving unit, a storage tank, a sealing unit, a switch unit and a feeding unit. An interior space of the storage tank is horizontally divided into a feeding space and a preparing space which have the same volume such that the feeding material, including viscous or cement-like materials, in the preparing space is configured to be transported into the feeding space with the same volume at a time to achieve volumetric feeding effect. Also, the feeding material in the feeding space is moved by a piston in a pushing manner thus preventing the feeding material from damage or heating during feeding process.

### FIELD OF THE INVENTION

The present invention relates to a volumetric feeder and more particularly to a piston-styled volumetric feeder capable of feeding viscous or cement-like materials.

### BACKGROUND OF THE INVENTION

Generally, referring to FIG. 14, a conventional feeder such as a first feeding unit (60) comprises a main body (61) which has a cylinder hole (611), and a rear end of the cylinder hole (611) is connected to a discharge opening (612). A vertical blocking unit (62) is formed between the cylinder hole (611) and the discharge opening (612), and a material sink (613) is connected to an upper end of the cylinder hole (611) and communicates with the cylinder hole (611). The material sink (613) is formed in an inverted-cone shape, and a diameter of a lower end of the material sink (613) is made corresponding to a diameter of an upper surface of the cylinder hole (611). Moreover, a piston (63) is movably formed at a lateral end of cylinder hole (611) for pushing feeding material. When the piston (63) is moved horizontally and leaves from the cylinder hole (611), the material in the material sink (613) is configured to flow directly and downwardly into the cylinder hole (611). Then, when the piston (63) is moved back and presses the material against the blocking unit (62), the material can flow out of the feeder through the discharge opening (612) thus achieving a feeding purpose. However, this kind of feeder has following disadvantages: (i) the material sink (613) of the first feeding unit (60) cooperated with the cylinder hole (611) and the piston (63) is formed in the inverted-cone shape. Although the material sink (613) can provide a space for storing material and feed the material into cylinder hole (611), it is only suitable for liquid materials. In case of applying to viscous or cement-like materials such as dough, puree and chopped meat, it is hard for feeding material to smoothly flow into the cylinder hole (611) thus failing to achieve the feeding effect; and (ii) since the material is not packed tightly and sealed, when the material in the cylinder hole (611) is pushed by the piston (63), parts of material may flow back to the material sink (613). When the feeding material in the material sink (613) is more than in the cylinder hole (611), there may be less amount of the materials flowing back to the material sink (613). On the contrary, when the feeding material in the material sink (613) is less than in the cylinder hole (611), there may be more amount of the material flowing back to the material sink (613) such that it is hard to achieve the effect of volumetric feeding. Moreover, this kind of the piston (63) of the feeder has no function of continuous discharge.

Furthermore, referring to FIG. 15, another kind of conventional feeder such as second feeding unit (70) comprises a material space (71) formed at a top end thereof, and a pressing wheel (711) is installed inside the material space (71). The second feeding unit (70) further has first channel (72) and second channel (73) which are communicated with the material space (71), and a first screw rod (74) and a second screw rod (75) are respectively installed inside the first channel (72) and the second channel (73). When feeding material such as dough and chopped meat is placed into the material space (71), the pressing wheel (711), the first screw rod (74), and the second screw rod (75) work together and grind and push the material to achieve the feeding effect. However, this kind of feeder still has following disadvantages: although the second feeding unit (70) can achieve the feeding effect for viscous materials, it may damage the material during feeding and transporting process. Therefore, there remains a need for a new and improved design for a volumetric feeder to overcome the problems presented above.

### SUMMARY OF THE INVENTION

The present invention provides a volumetric feeder which comprises a driving unit, a storage tank, a sealing unit, a switch unit and a feeding unit. The driving unit has a base, and a vertical plate protruding from an upper surface of the base is configured to divide the base into two parts, an actuating area and an operating area. Moreover, a servomotor is installed inside the base, and a belt connected to the servomotor is configured to couple with and drive a screw rod. The screw rod is rotatably and movably mounted on the actuating area, and a first end of the screw rod is connected to a piston. A first portion of the screw rod which is formed close to the operating area has a head portion, and a first slot formed at a lateral side of the piston is configured to receive and secure the head portion of the screw rod. A first surface of the piston has at least a sealing ring which is configured to contact with the storage tank, and the vertical plate has a piston port which is configured to allow the piston to pass through and to move in the operating area. Two proximity sensors respectively secured at two ends of the actuating area of the base are located at positions aligned with the screw rod and are configured to detect a position of the screw rod to send signals to the servomotor thus switching moving directions of the screw rod. The storage tank which has a bottom plate, two lateral plates and a front plate, is cooperated with the vertical plate to form a square-shaped interior space, and the bottom plate is secured on the operating area of the base while the front plate faces to the vertical plate. Two first sliding grooves, which are parallel with the bottom plate, are respectively located on two inner surfaces of the lateral plates, and two sectional surfaces of the two first sliding grooves are formed in a dovetail shape. Also, two elastic units are respectively secured in the two first sliding grooves. Based on a vertical height of the first sliding grooves, the interior space of the storage tank is horizontally divided into a lower part and an upper part, which are a feeding space and a preparing space. Also, a bottom end of the feeding space is connected to the bottom plate, and the feeding space and the preparing space have the same volume. A discharge opening penetrating through the front plate is configured to discharge a volumetric feeding material which is pushed by the piston, and the front plate further has an engaging slot located at a position corresponding to the two first sliding grooves. The sealing unit comprises at least a pneumatic sliding unit and a sealing plate, and the pneumatic sliding unit is located at a lateral side of the screw rod. Thus, the pneumatic sliding unit connected to the sealing plate is configured to horizontally move to allow the sealing plate to insert into the piston port of the storage tank. Moreover, each of the two elastic units comprises a second sliding groove which is configured to bear against and allow the sealing plate to slide therein thereby separating the interior space of the storage tank into the feeding space and the preparing space. Also, a blade formed at a front edge of the sealing unit is configured to insert into the engaging slot of the front plate thus achieving cutting effect. Also, through at least a wing screw, a first cushion unit is secured at a rear end of the actuating area of the base which is an end far from the vertical plate, and at least a second cushion unit is secured on the sealing plate. As a result, the first cushion unit is configured to provide a buffering effect when the sealing plate is pulled out from the storage tank, and the second cushion unit is borne against the vertical plate to provide a buffering effect when the sealing plate is inserted into the storage tank. The switch unit is secured on the front plate of the storage tank through a casing, and a cross-hole penetrating through the casing is communicated with the discharge opening. Furthermore, a switching cylinder is secured in the cross-hole, and the switch unit further comprises an actuating unit secured on the base of the driving unit. The switching cylinder is secured on and connected to an axle of the actuating unit to realize an operation. In addition, the switching cylinder has a through hole which is aligned and communicated with the discharge opening to achieve the feeding effect.

Comparing with conventional feeder, the present invention is advantageous because: (i) the feeding space and the preparing space of the storage tank have the same volume such that the feeding material including viscous or cement-like materials in the preparing space is configured to be transported into the feeding space with the same volume at a time to achieve volumetric feeding effect; (ii) the feeding material in the feeding space is moved by the piston in a pushing manner thus preventing the feeding material from damage or heating during feeding process; (iii) with the first male buckles, the first female buckles, the knob, the second male buckles and the second female buckles, the storage, the casing and the switching cylinder, the sealing plate are configured to be easily and quickly disengaged from the volumetric feeder of the present invention to clean and sterilize thus improving the hygiene safety during feeding processing; and (iv) the rollers are installed in the preparing space of the storage tank, and are configured to soften and allow the feeding material to firmly pack in the preparing space and the feeding space.

### BRIEF DESCRIPTION OF THE DRAWINGS

FIG. 1 is a three-dimensional assembly view of a volumetric feeder in the present invention.

FIG. 2 is a three-dimensional exploded view of the volumetric feeder in the present invention.

FIG. 3 is a sectional view of the volumetric feeder in the present invention.

FIG. 4 is a schematic view illustrating the volumetric feeder in the present invention is in use.

FIG. 5 is the second schematic view illustrating the volumetric feeder in the present invention is in use.

FIG. 6 is the third schematic view illustrating the volumetric feeder in the present invention is in use.

FIG. 7 is the fourth schematic view illustrating the volumetric feeder in the present invention is in use.

FIG. 8 is the fifth schematic view illustrating the volumetric feeder in the present invention is in use.

FIG. 9 is a schematic view illustrating the quick connection between parts of the volumetric feeder in the present invention.

FIG. 10 is the second schematic view illustrating the quick connection between parts of the volumetric feeder in the present invention.

FIG. 11 is the third schematic view illustrating the quick connection between parts of the volumetric feeder in the present invention.

FIG. 12 is a three-dimensional assembly view of another embodiment of the volumetric feeder in the present invention.

FIG. 13 is a schematic view of another embodiment illustrating the volumetric feeder in the present invention is in use.

FIG. 14 is a prior art.

FIG. 15 is a prior art.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

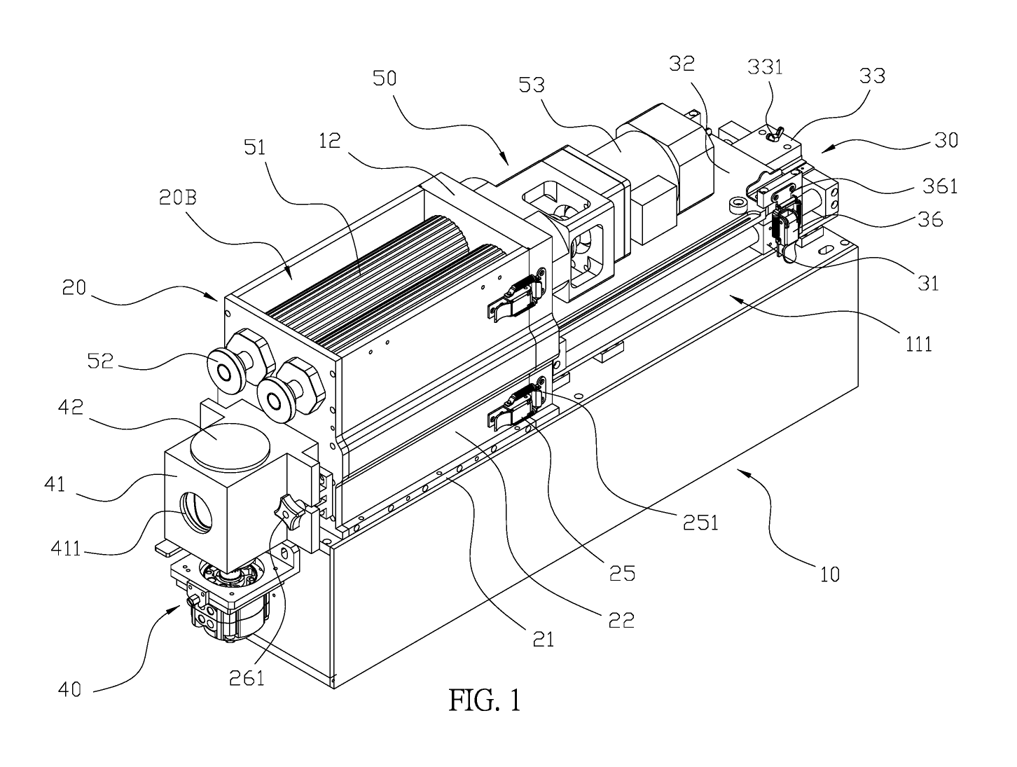

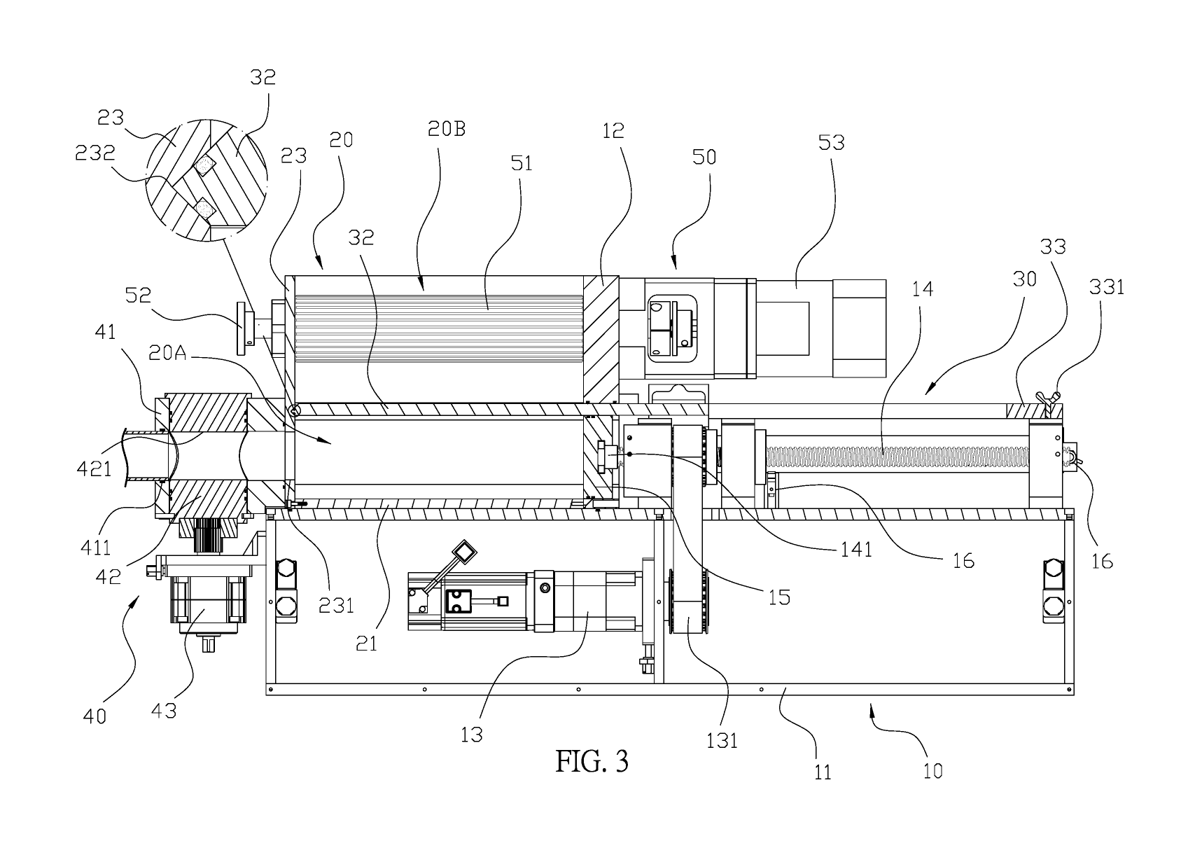

Referring to FIGS. 1 to 3, the present invention provides a volumetric feeder which comprises a driving unit (10), a storage tank (20), a sealing unit (30), a switch unit (40) and a feeding unit (50). The driving unit (10) has a base (11), and a vertical plate (12) protruding from an upper surface of the base (11) is configured to divide the base (11) into two parts, an actuating area (111) and an operating area (112). Moreover, a servomotor (13) is installed inside the base (11), and a belt (131) connected to the servomotor (13) is configured to couple with and drive a screw rod (14). The screw rod (14) is rotatably and movably mounted on the actuating area (111), and a first end of the screw rod (14) is connected to a piston (15). A first portion of the screw rod (14) which is formed close to the operating area (112) has a head portion (141), and a first slot (151) formed at a lateral side of the piston (15) is configured to receive and secure the head portion (141) of the screw rod (14). A first surface of the piston (15) has at least a sealing ring (152) which is configured to contact with the storage tank (20), and the vertical plate (12) has a piston port (121) which is configured to allow the piston (15) to pass through and to move in the operating area (112). Two proximity sensors (16) respectively secured at two ends of the actuating area (111) of the base (11) are located at positions aligned with the screw rod (14) and are configured to detect a position of the screw rod (14) to send signals to the servomotor (13) thus switching moving directions of the screw rod (14). The storage tank (20) which has a bottom plate (21), two lateral plates (22) and a front plate (23), is cooperated with the vertical plate (12) to form a square-shaped interior space, and the bottom plate (21) is secured on the operating area (112) of the base (11) while the front plate (23) faces to the vertical plate (12). Two first sliding grooves (221), which are parallel with the bottom plate (21), are respectively located on two inner surfaces of the lateral plates (22), and two sectional surfaces of the two first sliding grooves (221) are formed in a dovetail shape. Also, two elastic units (24) are respectively secured in the two first sliding grooves (221). Based on a vertical height of the first sliding grooves (221), the interior space of the storage tank (20) is horizontally divided into a lower part and an upper part, which are a feeding space (20A) and a preparing space (20B). Also, a bottom end of the feeding space (20A) is connected to the bottom plate (21), and the feeding space (20A) and the preparing space (20B) have the same volume. A discharge opening (231) penetrating through the front plate (23) is configured to discharge a volumetric feeding material which is pushed by the piston (15), and the front plate (23) further has an engaging slot (232) located at a position corresponding to the two first sliding grooves (221). The sealing unit (30) comprises at least a pneumatic sliding unit (31) and a sealing plate (32), and the pneumatic sliding unit (31) is located at a lateral side of the screw rod (14). Thus, the pneumatic sliding unit (31) connected to the sealing plate (32) is configured to horizontally move to allow the sealing plate (32) to insert into the piston port (121) of the storage tank (20). Moreover, each of the two elastic units (24) comprises a second sliding groove (241) which is configured to bear against and allow the sealing plate (32) to slide therein thereby separating the interior space of the storage tank (20) into the feeding space (20A) and the preparing space (20B). Also, a blade (321) formed at a front edge of the sealing unit (32) is configured to insert into the engaging slot (232) of the front plate (23) thus achieving cutting effect. Moreover, through at least a wing screw (331), a first cushion unit (33) is secured at a rear end of the actuating area (111) of the base (11) which is an end far from the vertical plate (12), and at least a second cushion unit (34) is secured on the sealing plate (32). As a result, the first cushion unit (33) is configured to provide a buffering effect when the sealing plate (32) is pulled out from the storage tank (20), and the second cushion unit (34) is borne against the vertical plate (12) to provide a buffering effect when the sealing plate (32) is inserted into the storage tank (20). The switch unit (40) is secured on the front plate (23) of the storage tank (20) through a casing (41), and a cross-hole (411) penetrating through the casing (41) is communicated with the discharge opening (231). Furthermore, a switching cylinder (42) is secured in the cross-hole (411), and the switch unit (40) further comprises an actuating unit (43) secured on the base (11) of the driving unit (10). The switching cylinder (42) is secured on and connected to an axle of the actuating unit (43) to realize an operation. In addition, the switching cylinder (42) has a through hole (421) which is aligned and communicated with the discharge opening (231) to achieve the feeding effect. The feeding unit (50) has two rollers (51) which are located inside the preparing space (20B) of the storage tank (20), and two rods (52) respectively penetrate through the front plate (23) and the vertical plate (12) into two inner spaces of the rollers (51) to secure the rollers (51). Moreover, a drive motor (53) secured on the vertical plate (12) is configured to rotate the rods (52) together with the rollers (51) to achieve an extruded feeding effect.

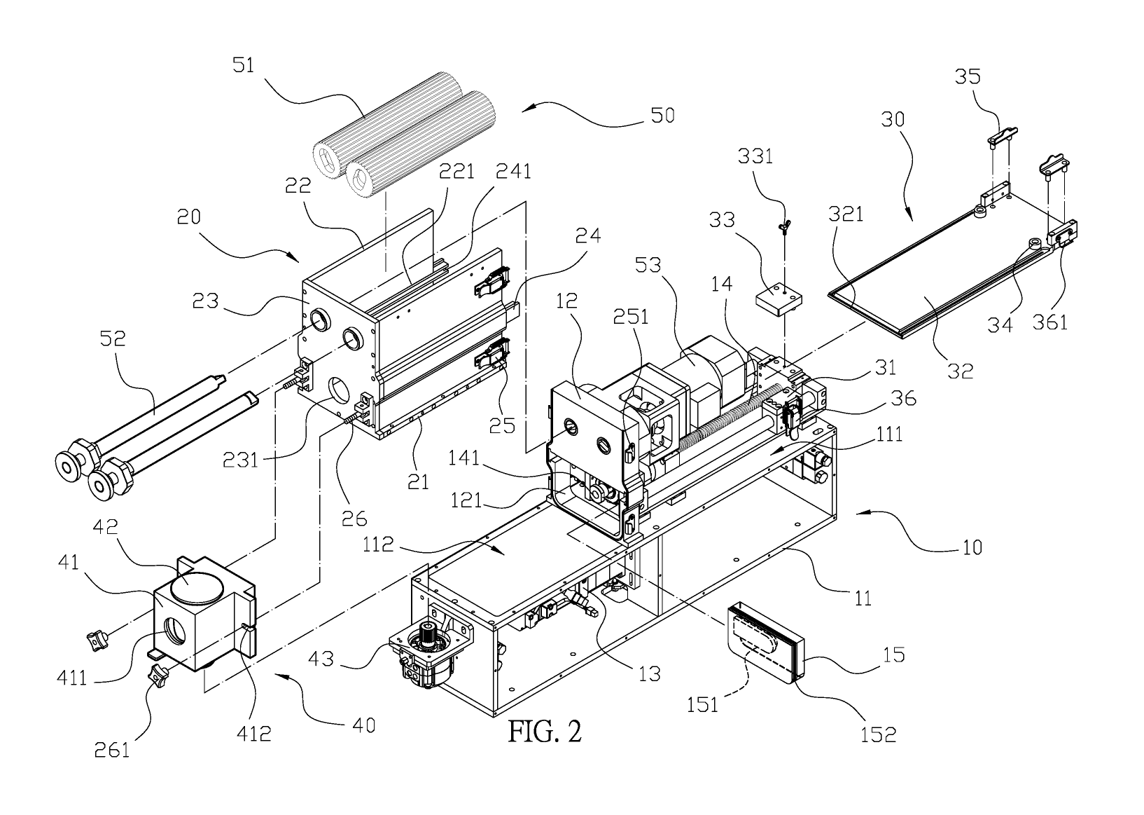

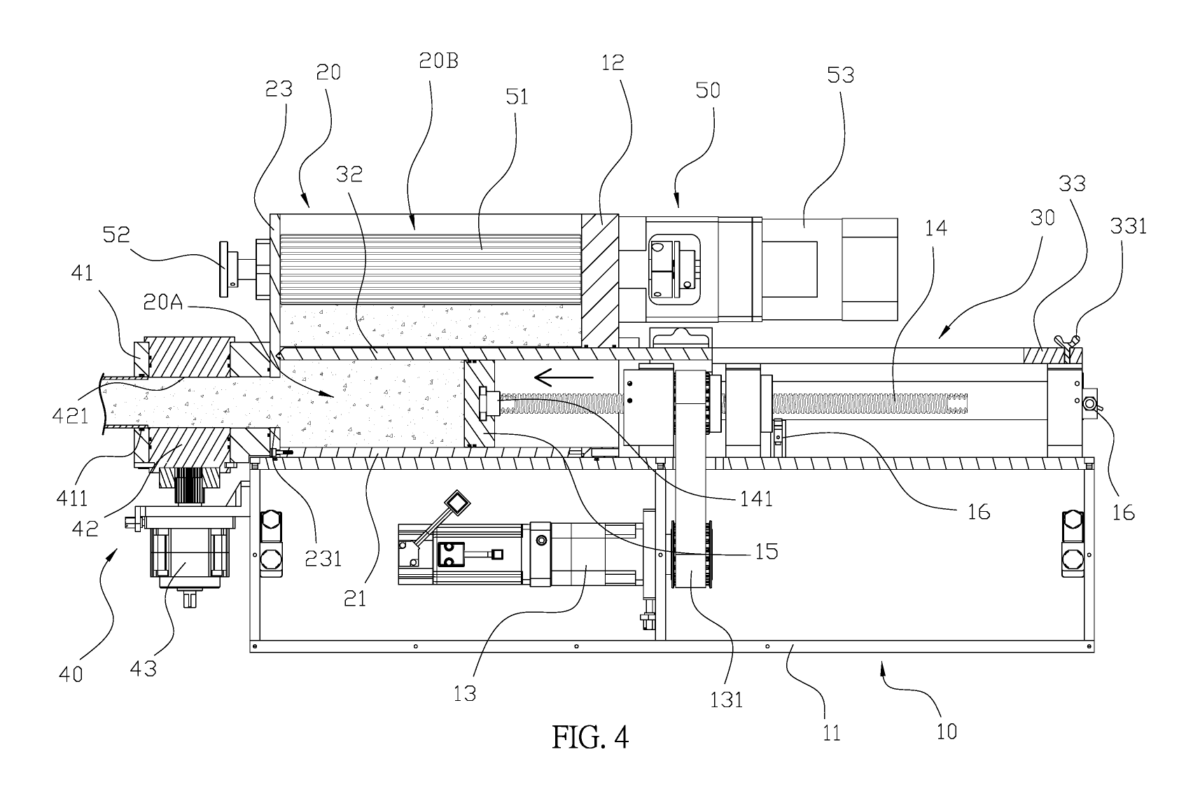

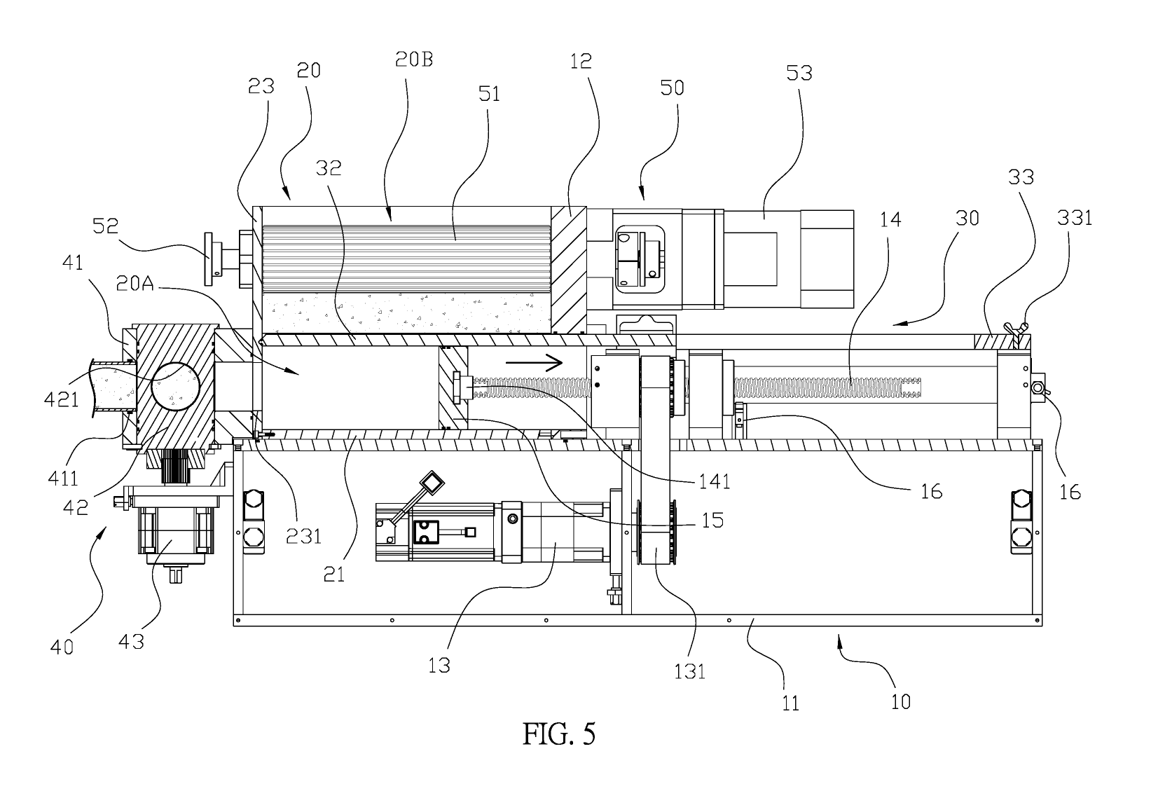

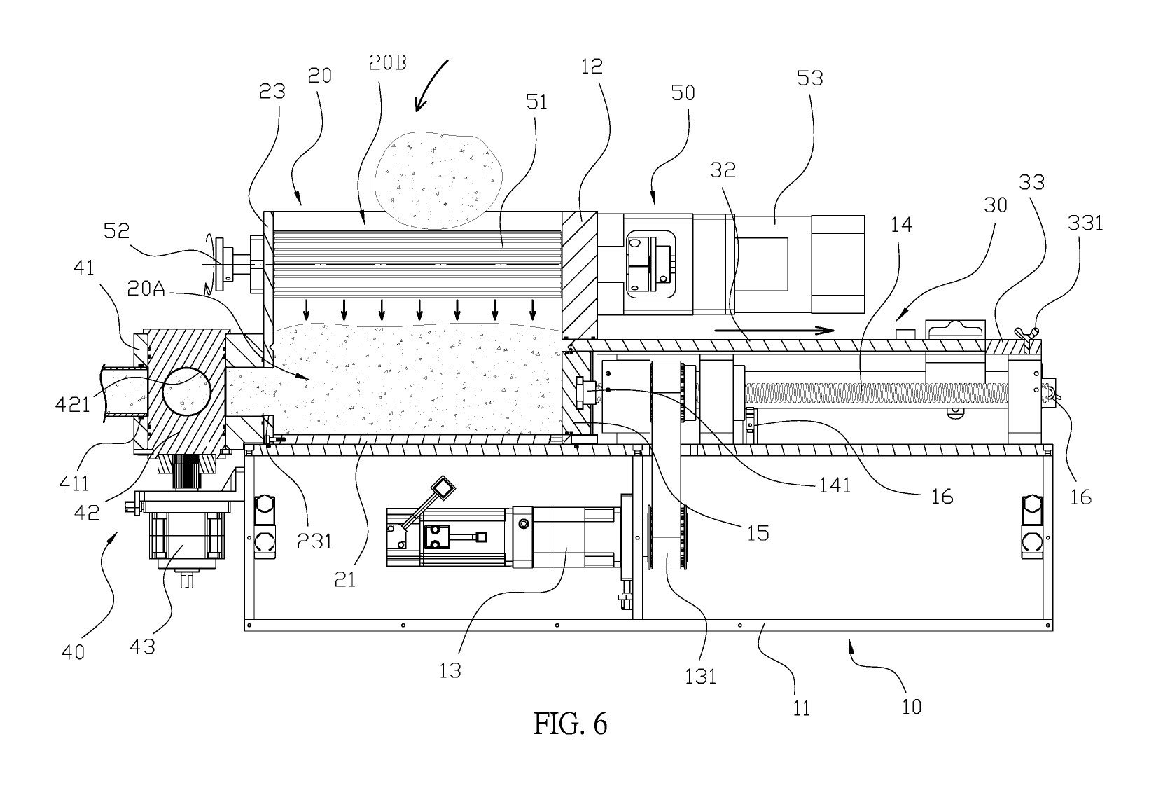

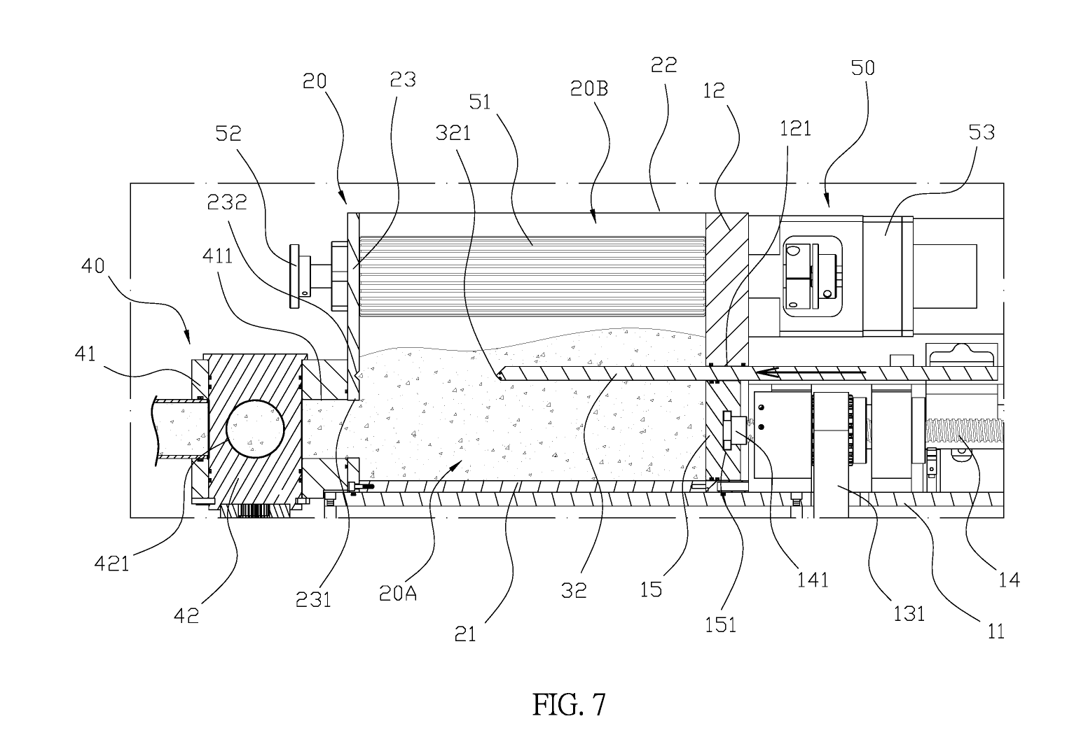

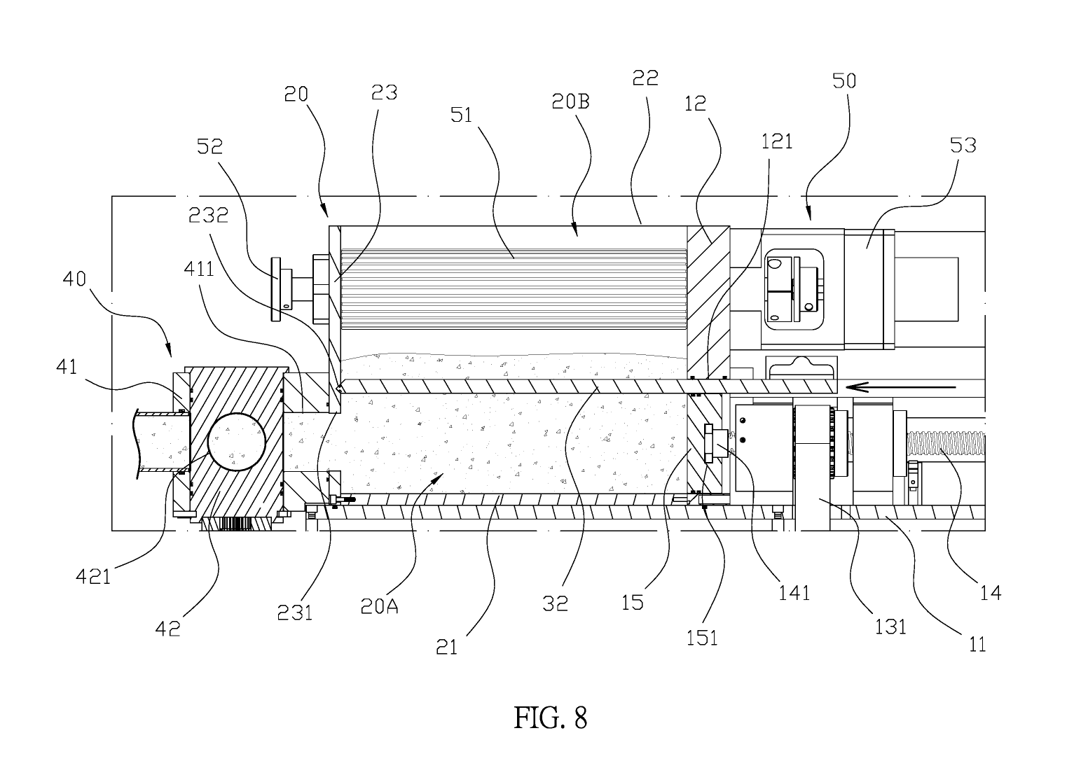

In actual application, referring to FIGS. 2 to 8, the servomotor (13) of the driving unit (10) is installed in the base (11), and the actuating area (111) of the base (11) has the screw rod (14). The belt (131) connected between the screw rod (14) and the servomotor (13) is configured to allow the screw rod (14) to move forward and backward with a constant speed. The two proximity sensors (16) respectively secured at the two ends of the actuating area (111) of the base (11) to detect the position of the screw rod (4). Also, the head portion (141) of the screw rod (14) is connected to the first slot (151) of the piston (15) such that the screw rod (14) is configured to push the piston (15) to achieve a reciprocating motion in the feeding space (20A) of the storage tank (20). Additionally, the storage tank (20) is secured on the operating area (112) of the base (11), and is formed in a square-shaped surrounded by the bottom plate (20), the lateral plates (22), the front plate (23) and the vertical plate (12). The sealing plate (32) of the sealing unit (30) is connected to the pneumatic sliding unit (31) which is secured on the actuating area (111) of the base (11), and the sealing plate (32) pushed by the pneumatic sliding unit (31) slides in the first sliding grooves (221) of the storage tank (20) thus sealing the feeding space (20A). The present invention is a piston-styled volumetric feeder capable of feeding viscous or cement-like materials such as dough, puree and chopped meat. The feeding material is filled in the feeding space (20A) of the storage tank (20), and redundant or supplementary feeding material is stored in the preparing space (20B). The screw rod (14) of the driving unit (10) is configured to move the piston (15) to squeeze and back away from the feeding space (20A) with a constant speed, and since the feeding material is tightly packed in the feeding space (20A) of the storage tank (20), it can be volumetrically discharged from the discharge opening (231). Wherein the piston (15) is configured to send the feeding material in a manner of pushing, which can keep the quality of the feeding material and prevent the feeding material from damage or heating during the feeding process. Also, the servomotor (14) is configured to control the moving speed of the screw rod (14) according to requirements, and can switch the moving directions when receiving the signals sent from the proximity sensors (16) thereby allowing the screw rod (14) together with the piston (15) to achieve the reciprocating motion. Meanwhile, the actuating unit (43) of the switch unit (40) is configured to rotate the switching cylinder (42) to misalign the through hole (421) of the switching cylinder (42) with the discharge opening (231) thus stopping the discharging action. Since the feeding material in the feeding space (20A) and the preparing space (20B) have the same volume, the volumetric feeding material in the preparing space (20B) is configured to fall into the feeding space (20A) when the sealing plate (32) driven by the pneumatic sliding unit (31) is removed from the storage tank (20). Also, the rollers (51) installed in the preparing space (20B) are configured to soften and allow the feeding material to firmly pack in the preparing space (20B) and the feeding space (20A). Furthermore, the front edge of the sealing plate (32) has the blade (321) which is configured to cut the feeding material when the sealing plate (32) is received back into the engaging slot (232) of the front plate (23). As a result, the feeding space (20A) and the preparing space (20B) are configured to keep the same volume of the feeding material therein, and the feeding material in the feeding space (20A) is configured to discharge from the discharge opening (231).

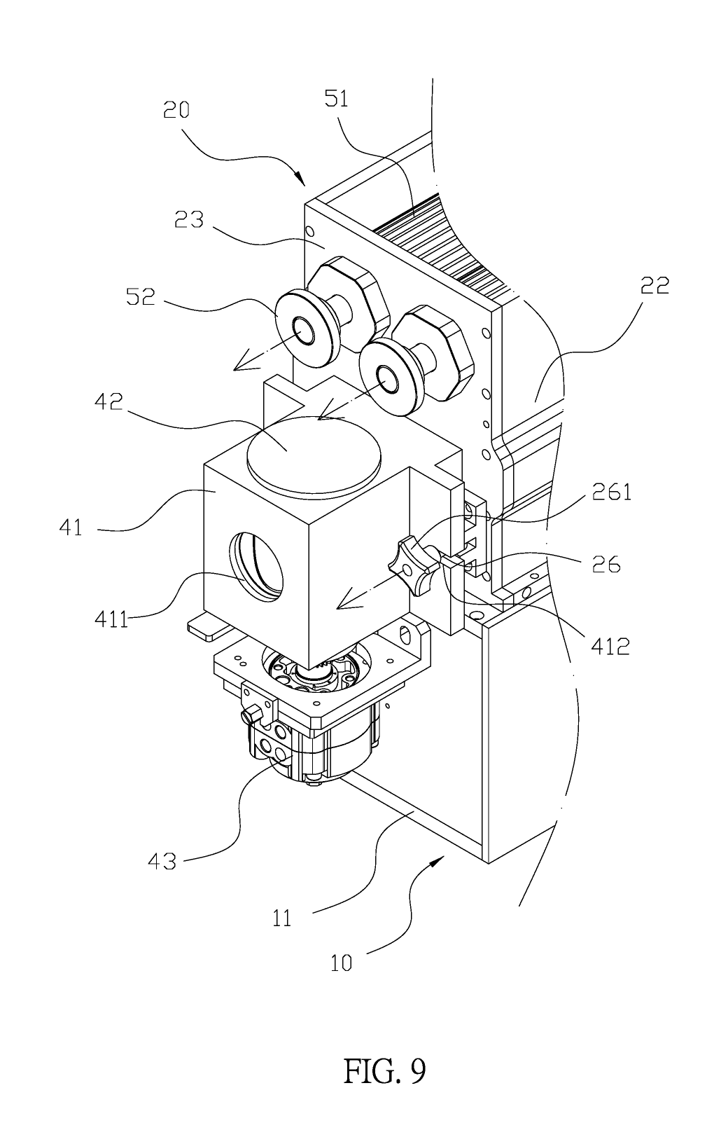

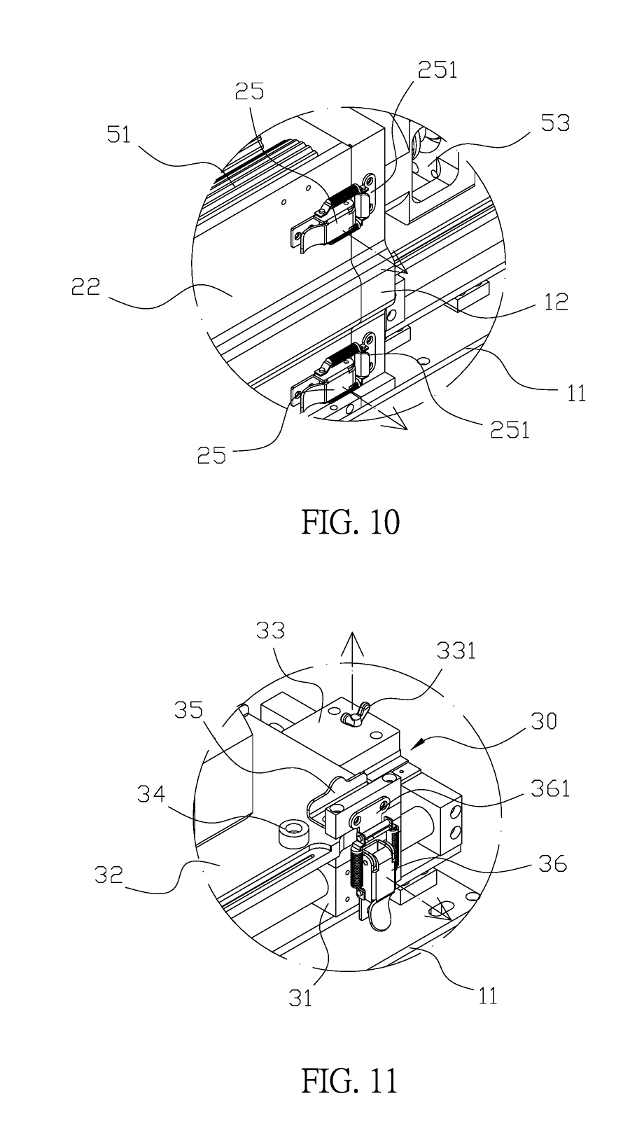

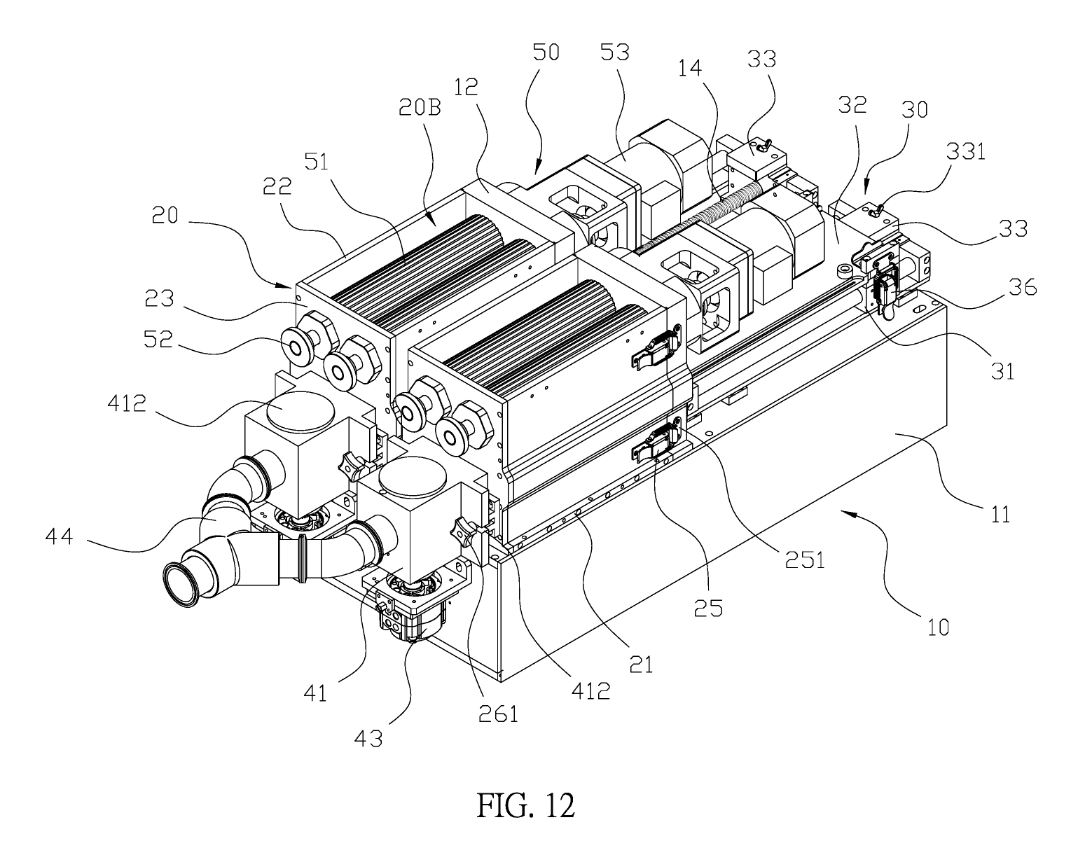

More specifically, referring to FIGS. 2 and 9 to 11, each of the lateral plates (22) of the storage tank (20) has a plurality of first male buckles (25) which are configured to engage with a plurality of first female buckles (251) secured on the vertical plate (12) such that the storage tank (20) is configured to quickly connect to the vertical plate (12). Moreover, a plurality of connecting rods (26) secured on the front plate (23) are configured to laterally penetrate through a plurality of notches (412) formed on the casing (41), and each of the connecting rods (26) has a knob (261) to achieve the effect of quick connection. As a result, the storage tank (20), the casing (41), and the switching cylinder (42) are configured to be disengaged and cleaned easily. Furthermore, the sealing plate (32) has at least a locating unit (35) which directly penetrates through and configured to locate the pneumatic sliding unit (31), and the sealing plate (32) further has a second female buckle (361) which is configured to engage with a second male buckle (36) secured on the pneumatic sliding unit (31) to achieve the effect of quick connection between the pneumatic sliding unit (31) and the sealing plate (32). Thus, the sealing plate (32) is easily disengaged from the pneumatic sliding unit (31) to clean and sterilize thereby improving the hygiene safety during feeding processing.

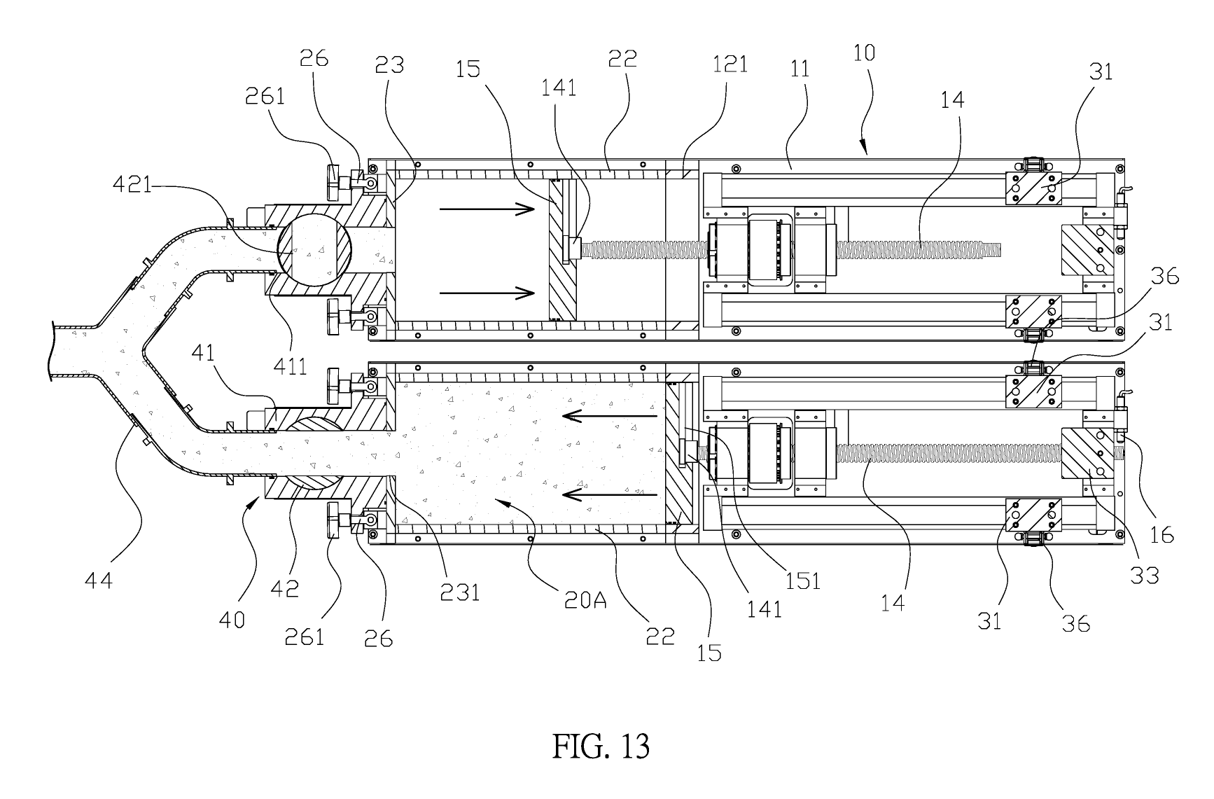

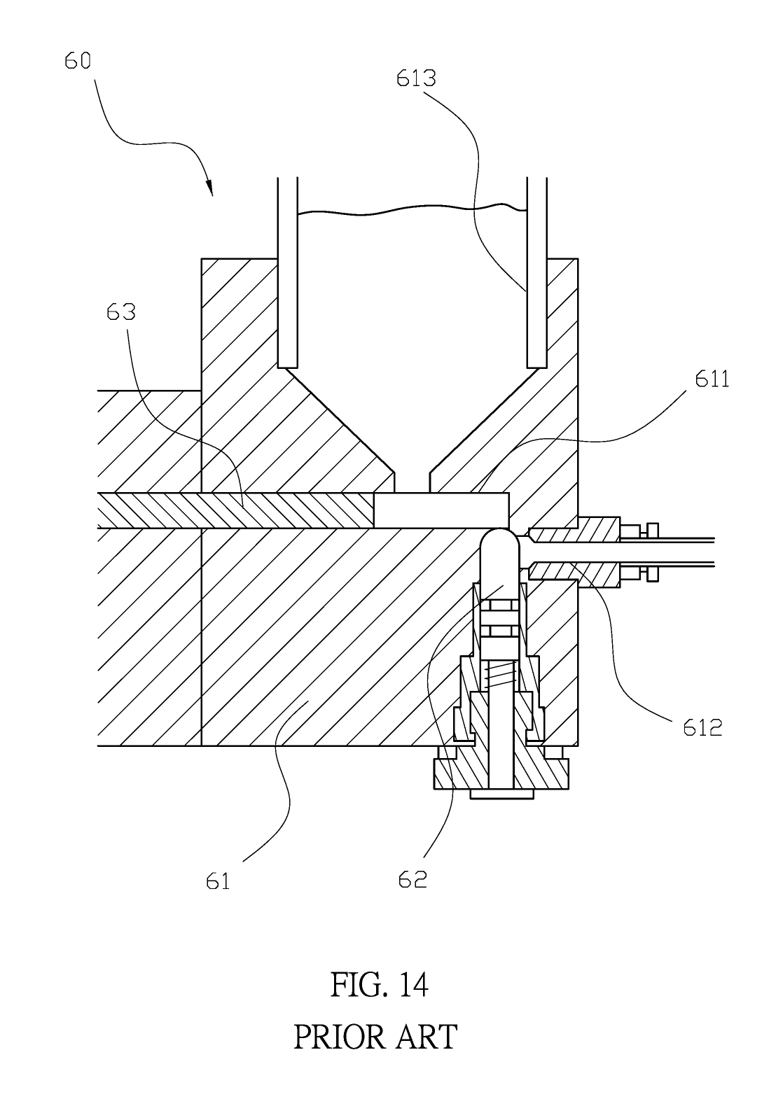

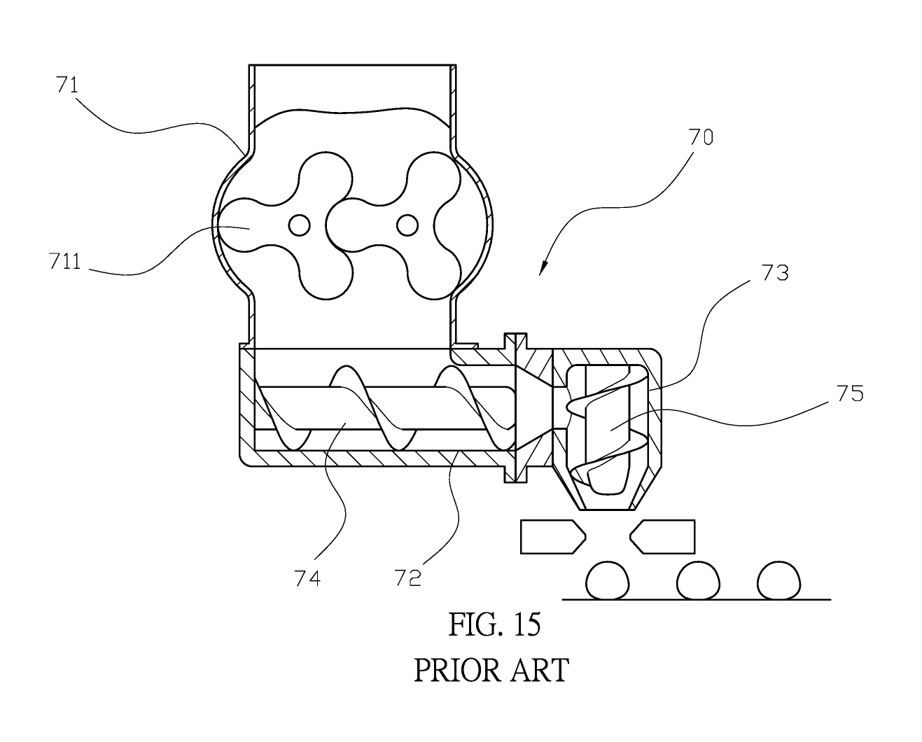

In another embodiment, referring to FIGS. 2, 12 and 13, two of the volumetric feeders of the present invention are configured to connect with each other. The cross-holes (411) of the switch units (40) in the two volumetric feeders are connected through a Y-shaped tube (44), and the feeding materials from the two different volumetric feeders are compiled and discharged from a collecting branch of the Y-shaped tube (44) thus achieving the effect of continuous discharge.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A volumetric feeder comprising:
a driving unit having a base, and a vertical plate, which protrudes from an upper surface of the base, configured to divide the base into two parts, an actuating area and an operating area; a servomotor installed inside the base, and a belt, which is connected to the servomotor, configured to couple with and drive a screw rod which is rotatably and movably mounted on the actuating area, and a first end of the screw rod connected to a piston; a piston port, which is formed on the vertical plate, configured to allow the piston to pass through and work in the operating area;
a storage tank, which has a bottom plate, two lateral plates and a front plate, cooperated with the vertical plate to form a square-shaped interior space, and the bottom plate secured on the operating area of the base while the front plate facing to the vertical plate, and two first sliding grooves, which are parallel with the bottom plate, respectively located on two inner surfaces of the two lateral plates; based on a vertical height of the first sliding grooves, the interior space of the storage tank horizontally divided into a feeding space and a preparing space which are respectively located at a lower part and an upper part of the storage tank, and a bottom end of the feeding space connected to an upper surface of the bottom plate, and the feeding space and the preparing space having the same volume; a discharge opening, which penetrates through the front plate, configured to discharge a volumetric feeding material pushed by the piston;
a sealing unit comprising at least a pneumatic sliding unit and a sealing plate, and the pneumatic sliding unit, which is secured on the actuating area, located at a lateral side of the screw rod and configured to horizontally move the sealing plate through the piston port into the storage tank thus separating the feeding space and the preparing space; and
a feeding unit having two rollers located inside the preparing space of the storage tank, and each of the rollers connecting a rod penetrating through the front plate and the vertical plate, and a drive motor, which is secured on the vertical plate, configured to rotate the rods together with the rollers to achieve an extruded feeding effect.

2. The volumetric feeder of claim 1, wherein two proximity sensors respectively secured at two ends of the actuating area of the base are located at positions aligned with the screw rod and are configured to detect a position of the screw rod to send signals to the servomotor thus switching moving directions of the screw rod.

3. The volumetric feeder of claim 1, wherein a first portion of the screw rod which is located close to the operating area has a head portion, and a first slot formed at a lateral side of the piston is configured to receive and secure the head portion of the screw rod, and a first surface of the piston has at least a sealing ring which is configured to contact with the storage tank.

4. The volumetric feeder of claim 1, wherein the front plate has an engaging slot located at a position corresponding to the two first sliding grooves, and a blade formed at a front edge of the sealing unit is configured to insert into the engaging slot of the front plate thus achieving cutting effect.

5. The volumetric feeder of claim 1, wherein two sectional surfaces of the two first sliding grooves are formed in a dovetail shape, and two elastic units are respectively secured in the two first sliding grooves, and each of the two elastic units comprises a second sliding groove which is configured to bear against and allow the sealing plate to slide therein.

6. The volumetric feeder of claim 1, wherein a first cushion unit secured by at least a wing screw is located at a rear end of the actuating area of the base which is an end far from the vertical plate, and at least a second cushion unit is secured on the sealing plate such that the first cushion unit is configured to provide a buffering effect when the sealing plate is pulled out from the storage tank, and the second cushion unit is borne against the vertical plate to provide a buffering effect when the sealing plate is inserted into the storage tank.

7. The volumetric feeder of claim 1, wherein a switch unit is secured on the front plate of the storage tank through a casing, and a cross-hole penetrating through the casing is communicated with the discharge opening, and a switching cylinder is secured in the cross-hole; wherein the switch unit further comprises an actuating unit secured on the base of the driving unit, and the switching cylinder is secured on and connected to an axle of the actuating unit to realize an operation; and wherein the switching cylinder has a through hole which is aligned and communicated with the discharge opening to achieve the feeding effect.

8. The volumetric feeder of claim 7, wherein two of the volumetric feeders are configured to cooperate with each other, and the two cross-holes of the switch units in the two volumetric feeders are connected through a Y-shaped tube, and the feeding materials from the two different volumetric feeders are compiled and discharged from a collecting branch of the Y-shaped tube thus achieving the effect of continuous discharge.

9. The volumetric feeder of claim 1, wherein each of the lateral plates of the storage tank has a plurality of first male buckles which are configured to engage with a plurality of first female buckles secured on the vertical plate such that the storage tank is configured to quickly connect to the vertical plate, and a plurality of connecting rods secured on the front plate are configured to laterally penetrate through a plurality of notches formed on the casing, and each of the connecting rods has a knob to achieve the effect of quick connection and disconnection.

10. The volumetric feeder of claim 1, wherein the sealing plate has at least a locating unit which directly penetrates through the pneumatic sliding unit, and a second female buckle formed on the sealing plate is configured to engage with a second male buckle secured on the pneumatic sliding unit to achieve the effect of quick connection and disconnection between the pneumatic sliding unit and the sealing plate thus allowing the clean and sterilization of the sealing plate easier.
